(19) United States
(12) Patent Application Publication
(10) Pub. No.: US 2005/0151659 A1
(43) Pub. Date: Jul. 14, 2005

(54) Transmission/distribution line fault indicator with remote polling and current sensing and reporting capability

(76) Inventors: David L. Donovan, Foxboro, MA (US); Robert E. Joyce, Shaker Heights, OH (US); Lance P. Sabados, North Ridgeville, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/010,645

(22) Filed: Dec. 13, 2004

Related U.S. Application Data
(60) Provisional application No. 60/528,851, filed on Dec. 11, 2003.

(51) Int. Cl. G08B 21/00

(52) U.S. Cl. 340/664; 324/512

(57) ABSTRACT

The present invention includes a fault indicator for an electrical transmission line comprising: a fault indicator circuit; and a remote communicator operatively coupled to the fault indicator circuit to transmit condition data to a remote location, where such condition data includes current load data. The invention also includes a method of monitoring and responding to current faults and load variations across an electrical transmission network, the method comprising: installing two fault indicators in electrical communication with an electrical transmission network and including two-way communication capability; generating, by the two fault indicators, condition data specific to a respective location of each of the two fault indicators, where such condition data includes current load data; transmitting the condition data from the two fault indicators to a remote location; receiving, at the remote location, the condition data transmitted from the two fault indicators; and, monitoring and processing the condition data received.

### CROSS REFERENCE TO RELATED APPLICATIONS

This application claims the benefit of U.S. Provisional Patent Application Ser. No. 60/528,851, filed Dec. 11, 2003, and entitled “TRANSMISSION/DISTRIBUTION LINE FAULT INDICATOR WITH REMOTE POLLING AND CURRENT SENSING AND REPORTING CAPABILITY,” the disclosure of which is incorporated herein by reference.

### BACKGROUND

1. Field of the Invention

The present invention is directed to fault indicators and systems using the same, where the fault indicators monitor conditions of transmission/distribution lines along an electrical transmission/distribution network.

2. Background of the Invention

Electrical transmission/distribution lines convey electric current from generation stations to points of use. Numerous problems may arise during the transmission/distribution of electric current such as faults and large current usage disparities between network grids. Fault indicators were developed, in response to a need, to identify the location of faults in electrical transmission/distribution networks and to automatically reset such fault indicators upon revival of the transmission/distribution current through the electrical line operatively coupled thereto. Other developments in the area of fault identification are summarized below.

The Fisher Pierce Series 1516 Voltage-Reset Fault Indicators (available from the assignee of the present invention) locate faults by monitoring line current. The indicator trips to the fault position when the monitored line current exceeds the selected trip rating. A secondary voltage source, such as the low-voltage terminals of distribution transformers, is utilized to reset the display to the normal position. The fault indicators are reset automatically upon restoration of secondary voltage. This type of fault indicator is ideal for use on lightly loaded circuits where insufficient load current may be available to reliably reset a fault indicator. Fault registration and indication is provided by means of a latching relay “flag type” indicator mounted remotely or directly on the distribution cable. The fault indicator functions to improve service and decrease outages and revenue loss.

The Fisher Pierce Series 1547 Adaptive Trip Faulted Circuit Indicator (FCI) (available from the assignee of the present invention) indicates a fault condition after sensing continuous load current followed by a rapid increase of fault current, followed by a loss of load current. The innovative Adaptive Trip™ circuitry automatically adjusts for changes in distribution feeder load currents from 1 to 800 amps. This indicator is adaptable system-wide to eliminate trip selection errors, load studies to determine FCI applications, and change-outs due to load growth. Display options include flag, LED, remote fiber optic display, radio or SCADA contact output. The inrush restraint function avoids false trips due to cold load pickup, recloser operations, and other occurrences. Configurations are available for both overhead and underground applications.

The Fisher Pierce 1560-1 handheld radio receiver (available from the assignee of the present invention) is a portable device that decodes phase fault status information transmitted from the Fisher Pierce Radio Faulted Circuit Indicators and gives both a visual display and an audible alarm. The handheld device receives data remotely, enabling field personnel to quickly locate faulted FCIs and their status.

The Fisher Pierce 1560-2 and 1560-3 Remote transmission/distribution Unit/Supervisory Control and Data Acquisition RTU/SCADA radio receiver (available from the assignee of the present invention) is designed for transmission/distribution RTU/SCADA overhead applications. The isolated relay contact closure of Fisher Pierce radio type receivers can easily be interfaced to most standard remote terminal units. Up to three overhead/hotstick Radio Faulted Circuit Indicators (RFCIs) communicate with this device. The RTU/SCADA radio receivers are enclosed in a weatherproof NEMA-3 housing for mounting inside or outside of a remote terminal unit.

The Fisher Pierce Radio Faulted Circuit Indicator Systems utilize wireless communication technology to assist in locating distribution system faulted circuits. RFCI's installed in overhead, underground, and padmount locations can be detected from handheld and pole mounted radio receivers. Linemen in a moving vehicle can quickly locate the RFCI and receive their alarm status with a handheld device. The internal radio transmitter reports the faulted phase information to a handheld or a SCADA receiver. The handheld receiver has an audible alarm and an LED display with phase indication. The SCADA receiver connects to remote terminal status inputs and reports individual phase faults. Fisher Pierce faulted circuit indicators include models with inrush restraint, manual reset, time delay reset, current reset, and Adaptive Trip™ features.

### SUMMARY OF THE INVENTION

The present invention is directed to fault indicators and systems using the same, where the fault indicators monitor conditions of transmission/distribution lines along an electrical transmission/distribution network. Such fault indicators provide multiple functionality and transmit fault sensing data, as well as other condition data to a remote location for processing. The fault indicators of the present invention may include one-way communication to transmit the condition data to a remote location, or be provided with two-way communication capability to respond to a polling request from a remote location and transmit condition data in response to such a request. In a further detailed exemplary embodiment, the fault indicators include memory devices operatively coupled thereto to log the real-time data in a chronological fashion. Such log data may be transmitted to a remote monitoring station in a data packet at predetermined intervals, or may likewise include a cyclical memory storage that continuously saves over existing, previously logged condition data.

### BRIEF DESCRIPTION OF THE DRAWING

FIG. 1 is a schematic diagram of an exemplary embodiment of the present invention.

### DETAILED DESCRIPTION

It should be understood that the following detailed description of exemplary embodiments of the present invention are exemplary in nature and are not intended to constitute limitations upon the present invention. It is also to be understood that variations of exemplary embodiments contemplated by one of ordinary skill in the art shall concurrently fall within the scope and spirit of the invention. Although certain aspects of the exemplary embodiments are shown in more detail, some features within the purview of one skilled in the art may have been omitted for the sake of clarity and brevity.

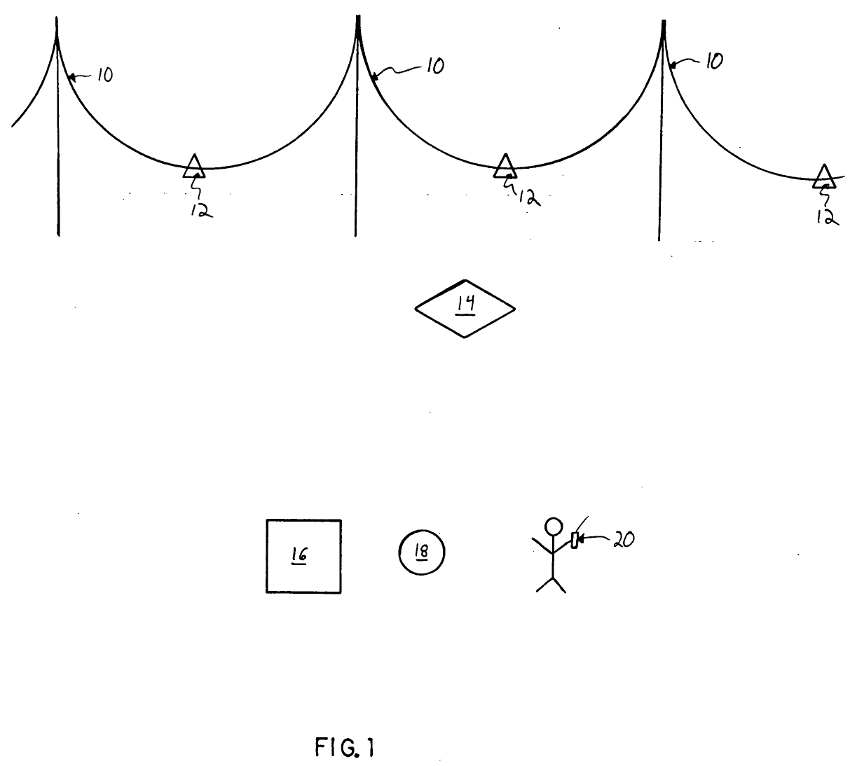

Referencing FIG. 1, a schematic diagram is provided showing an electrical transmission/distribution line 10 having a plurality of fault indicators 12 in accordance with the present invention. The fault indicators 12 include remote communication capability to transmit condition data to a local receiving center 14, a central monitoring station 16, a mobile monitoring station (such as, without limitation, a pick-up truck or a maintenance/bucket truck) 18, and/or a handheld monitoring device 20.

The condition data that is transmitted from the fault indicators 12 of the present invention may include, for example, without limitation, current load, fault indication data and/or fault signature data. The fault indication data is analogous to prior art fault indication data and may be supplemented with audible and/or visual indications indicating a fault. Such audible and visual indications include, without limitation, lighted displays (such as solid or flashing LEDs) and audible speakers (providing a chirping sound or other audible indication of a fault).

In a further detailed exemplary embodiment, the fault indicators 12 include two-way communication capability enabling the indicators to receive polling requests/data from a remote location 14, 16, 18, 20 and respond appropriately. Such an appropriate response might include transmitting current load data and/or fault indication data specific to the polling request if such a request is itself specific in nature. An additional feature of the present invention is the ability to provide real-time transmission/distribution condition data from indicators to one or more remote locations 14, 16, 18, 20 and between indicators 12 themselves.

In a further detailed exemplary embodiment, the fault indicator 12 logs the condition data in an on-board storage medium. Exemplary on-board storage devices include digital and analog memory devices well known to those of ordinary skill. In an alternate exemplary embodiment, the fault indicator 12 is configured to transmit condition data in real-time to the local receiving center 14 where the condition data is stored on an on-board storage medium and/or retransmitted in real-time to one or more of the receiving units 16, 18, 20. Such a retransmission may be initiated by a polling request by one or more of the remote units 16, 18, 20.

In a further detailed exemplary embodiment, a method is provided for monitoring and responding to current faults and load variations across an electrical transmission/distribution network. The method includes installing a plurality of remote communication capable fault indicators 12 that are operatively coupled to a plurality of electrical transmission/distribution lines 10 of an electrical transmission/distribution line network. A transmission/distribution network monitoring center 16 is adapted to receive condition data from a plurality of indicators 12 and/or a plurality of local receiving centers 14. As discussed in a previous embodiment above, the condition data transmitted from the indicators 12 provides real-time feedback regarding the present network conditions at locations along the transmission/distribution network where an indicator 12 is located. By tracking the condition data at a central receiving station 16, a single operator may alter the current transmitted across a particular transmission/distribution line or plurality of lines in response detected faults and/or disproportionate current loads.

In a further detailed exemplary embodiment, the portable remote units 18, 20 provide a data gateway to one or more of the indicators 12, one or more of the remote stations 14 (acting as retransmitters), and the central monitoring station 16. In such an exemplary embodiment, the portable remote units 18, 20 provide two-way communication capability to receive condition data concurrently from one or more of the indicators 12, one or more of the remote stations 14 (acting as re-transmitters), and the central monitoring station 16. The condition data received is processed to construct an electronic grid detailing the changes in the transmission/distribution network in real-time. The remote units 18, 20 may utilize this condition data to alter the current transmission/distribution across the electrical transmission/distribution line network.

Following from the above description and invention summaries, it should be apparent to those of ordinary skill in the art that, while the methods and apparatuses herein described constitute exemplary embodiments of the present invention, the invention contained herein is not limited to these precise embodiments and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

1. A fault indicator for an electrical transmission line comprising:
a fault indicator circuit; and
a remote communicator operatively coupled to the fault indicator circuit to transmit condition data to a remote location, where such condition data includes current load data.

2. The fault indicator of claim 1, wherein:
the remote communicator includes two-way communication capability; and
the remote communicator is adapted to receive polling data from the remote location and transmit condition data to the remote location in response to the polling data.

3. The fault indicator of claim 1, wherein:
the condition data includes at least one of fault location data and current load data; and
the condition data is transmitted in real-time from available real-time generated condition data and available stored condition data.

4. The fault indicator of claim 1, further comprising at least one of a visual indicator and an audible indicator providing feedback regarding at least one of a fault and a current load associated with a electrical transmission, where the visual indicator includes a light emitting diode and the audible indicator includes a speaker.

5. An electrical transmission line network comprising:
a plurality of fault indicator circuits operatively coupled to a plurality of lines of an electrical transmission network, where each of the plurality of fault indicator circuits is operatively coupled to a remote communication device adapted to transmit condition data; and
a remote station adapted to receive current load data transmitted from two or more remote communication devices.

6. An electrical transmission line network wherein:
at least one remote communication device is operative to transmit at least one of real-time condition data and stored condition data to the remote station, where at least one of the real-time condition data and the stored condition data includes current load data; and
the stored condition data is stored on an on-board medium operatively coupled to the remote communication device.

7. A method of monitoring and responding to current faults and load variations across an electrical transmission network, the method comprising:
installing two fault indicators in electrical communication with an electrical transmission network and including two-way communication capability;
generating, by the two fault indicators, condition data specific to a respective location of each of the two fault indicators, where such condition data includes current load data;
transmitting the condition data from the two fault indicators to a remote location;
receiving, at the remote location, the condition data transmitted from the two fault indicators; and
monitoring and processing the condition data received.

8. The method of claim 7, further comprising:
polling, from the remote location, the two fault indicators to request condition data specific to the respective location of each of the two fault indicators, where such condition data includes at least one of current fault data and load data;
where the act of monitoring and processing the condition data received includes at least one of re-routing a load and adjusting a load on the electrical transmission network in response to the condition data received.

9. The method of claim 7, further comprising:
storing the condition data generated by the two fault indicators on a storage medium operatively coupled to the remote location; and
adjusting at least one electrical load on the electrical transmission network in response to the condition data received;
where the act of transmitting the condition data from the two fault indicators to a remote location includes transmitting the condition data from at least one of the storage medium and the two fault indicators to the remote location;
where the act of monitoring and processing the condition data received includes monitoring the condition data received from at least one of the storage medium and the two fault indicators.
